(19) United States
(12) Patent Application Publication
(10) Pub. No.: US 2011/0194228 A1
(43) Pub. Date: Aug. 11, 2011

(54) DIELECTRIC CERAMIC AND LAMINATED CERAMIC CAPACITOR

(75) Inventor: Masayuki Ishihara, Nagaokakyo-shi (JP)

(73) Assignee: MURATA MANUFACTURING CO., LTD., Nagaokakyo-Shi (JP)

(21) Appl. No.: 13/017,451

(22) Filed: Jan. 31, 2011

(30) Foreign Application Priority Data
Feb. 10, 2010 (JP) 2010-027278

(51) Int. Cl. H01G 4/30; C04B 35/468

(52) U.S. Cl. 361/301.4; 501/137

(57) ABSTRACT

To increase the dielectric constant of a dielectric ceramic containing ABO₃ (A being Ba alone or further containing at least one of Ca and Sr, and B is Ti alone or or further contains at least one of Zr and Hf) as its main constituent and containing Re (Re is at least one of Dy, Ho, Sc, Y, Gd, Er, Yb, Tb, Tm, and Lu) as an accessory constituent, the main phase grains are ABO₃ based main constituent and secondary phase grains have a different composition from the main phase grains. More Re is concentrated in the secondary phase grains in such a way that the ratio of the content of Re in the secondary phase grains to the total content of Re in the dielectric ceramic is 50% or more. The content of Re in the secondary phase grains is preferably 30 mol % or more.

### BACKGROUND OF THE INVENTION

1. Field of the Invention

The present invention relates to a dielectric ceramic and a laminated ceramic capacitor composed with the use of the dielectric ceramic, and more particularly, relates to an improvement for the purpose of increasing the dielectric constant of a dielectric ceramic.

2. Description of the Related Art

There has been an attempt to reduce the thickness of dielectric ceramic layers provided in the laminated ceramic capacitors as one of effective means for fulfilling the demands of reduction in size and increase in capacitance.

However, the reduction in the thickness of the dielectric ceramic layers not only makes it hard to ensure electrical insulation, but also increases the electric field intensity per dielectric ceramic layer, thereby encountering the problem that the dielectric constant is likely to be decreased. Therefore, in order to fulfill the demands of reduction in size and increase in capacitance in laminated ceramic capacitors, it has been desired to increase the dielectric constant of the dielectric ceramic constituting the dielectric ceramic layers as much as possible.

For dielectric ceramics containing a barium titanate based material as their main constituent, techniques for increasing the dielectric constants of the dielectric ceramics have been proposed, for example, in Japanese Unexamined Patent Publication No. 2002-265260. The dielectric ceramic described in Japanese Unexamined Patent Publication No. 2002-265260 will be described with reference to FIG. 3. FIG. 3 is a diagram schematically illustrating an enlarged dielectric ceramic 21.

The dielectric ceramic 21 described in Japanese Unexamined Patent Publication No. 2002-265260 contains a barium titanate based material as its main constituent, and includes main phase grains 22 composed of the main constituent and has grain boundaries (including triple points) 23 with a produced composite oxide containing a rare earth element and Si. The phase containing Si is referred to as a low dielectric constant phase. Furthermore, in the case of the dielectric ceramic 21 described in Japanese Unexamined Patent Publication No. 2002-265260, such a low dielectric constant phase is thin and broadly distributed at the grain boundaries 23.

With an assumption that the dielectric ceramic 21 has been used for constituting the dielectric ceramic layers provided in the laminated ceramic capacitors, when one draws a straight line extending in the stacking direction between internal electrodes, the grains are distributed along this straight line, such as main phase grain—grain boundary—main phase grain—grain boundary—main phase grain—grain boundary—main phase grain— . . . , so that several grain boundaries 23 are interposed in series between main phase grains 22. When the combined capacitance in series, the capacitance of the main phase grain 22, and the capacitance of a low dielectric constant phase containing Si distributed at the grain boundaries 23 are denoted respectively by C, C1, and C2, the combined capacitance C is represented as follows.

1/C=1/C1+1/C2+1/C1+1/C2+1/C1+1/C2+1/C1+

In the formula above, when the low dielectric constant phase is thin and broadly distributed at the grain boundaries 23, the large number of terms 1/C2 will increase the value of 1/C, and thus decreases the combined capacitance C. From this reason, the dielectric ceramic 21 described in Japanese Unexamined Patent Publication No. 2002-265260 has a low dielectric constant as a whole.

It is to be noted that when the number of main phase grains 22 is reduced by grain growth in the dielectric ceramic 21, the number of grain boundaries 23 with the straight line passing therethrough is also reduced, and the decrease in dielectric constant can be thus suppressed. However, a problem is encountered in this case in that the capacitance-temperature characteristics of the laminated ceramic capacitor is likely to be degraded.

### SUMMARY OF THE INVENTION

Therefore, an object of the present invention is to provide a dielectric ceramic which can solve the problems described above, and a laminated ceramic capacitor composed with the use of the dielectric ceramic.

The present invention is first directed to a dielectric ceramic containing ABO₃ (A necessarily contains Ba, and optionally further contains at least one of Ca and Sr, whereas B necessarily contains Ti, and optionally further contains at least one of Zr and Hf) as its main constituent and containing a rare earth element Re (Re is at least one of Dy, Ho, Sc, Y, Gd, Er, Yb, Tb, Tm, and Lu) as an accessory constituent, which is characterized by having the following aspects in order to solve the technical problems described above.

More specifically, a dielectric ceramic according to the present invention includes main phase grains which are composed of the main constituent mentioned above and secondary phase grains which have a different composition from the main phase grains, and is characterized in that the ratio of the content of Re in the secondary phase grains to the total content of Re in the dielectric ceramic is 50% or more.

In the dielectric ceramic according to the present invention, the content of Re in the secondary phase grains is preferably 30 mol % or more.

The present invention is also directed to a laminated ceramic capacitor including a capacitor main body composed with the use of a plurality of stacked dielectric ceramic layers and a plurality of internal electrodes formed along the specific interfaces between the dielectric ceramic layers, and a plurality of external electrodes formed in different positions from each other on the outer surface of the capacitor main body and electrically connected to specific ones of the internal electrodes.

The laminated ceramic capacitor according to the present invention is characterized in that the dielectric ceramic layers are composed of the above-mentioned dielectric ceramic according to the present invention.

In the dielectric ceramic according to the present invention, more low dielectric constant phases containing Re are distributed so as to be concentrated in secondary phase grains, in such a way that the ratio of the content of Re in the secondary phase grains to the total content of Re in the dielectric ceramic is 50% or more. Thus, the low dielectric constant phases are increased in size, whereas the low dielectric constant phases are reduced in number. Therefore, the low dielectric constant phases will have a smaller effect, thus resulting in an improvement in the dielectric constant of the dielectric ceramic as a whole.

In the dielectric ceramic according to the present invention, when the content of Re in the secondary phase grains is 30 mol % or more, the secondary phase grains can be reduced in size without increasing the number of secondary phase grains. Therefore, the uniformity of the dielectric ceramic is increased to allow the insulation and reliability to be increased.

Therefore, the improvement in the dielectric constant of the dielectric ceramic constituting the dielectric ceramic layers allows the laminated ceramic capacitor to be reduced in size when the laminated ceramic capacitor is composed with the use of the dielectric ceramic according to the present invention.

### BRIEF DESCRIPTION OF THE DRAWINGS

FIG. 1 is a cross-sectional view schematically illustrating a laminated ceramic capacitor 1 composed with the use of a dielectric ceramic according to the present invention;

FIG. 2 is a diagram schematically illustrating an enlarged dielectric ceramic 11 according to the present invention; and

FIG. 3 is a diagram schematically illustrating an enlarged conventional dielectric ceramic 21 of interest to the present invention.

### DETAILED DESCRIPTION OF THE INVENTION

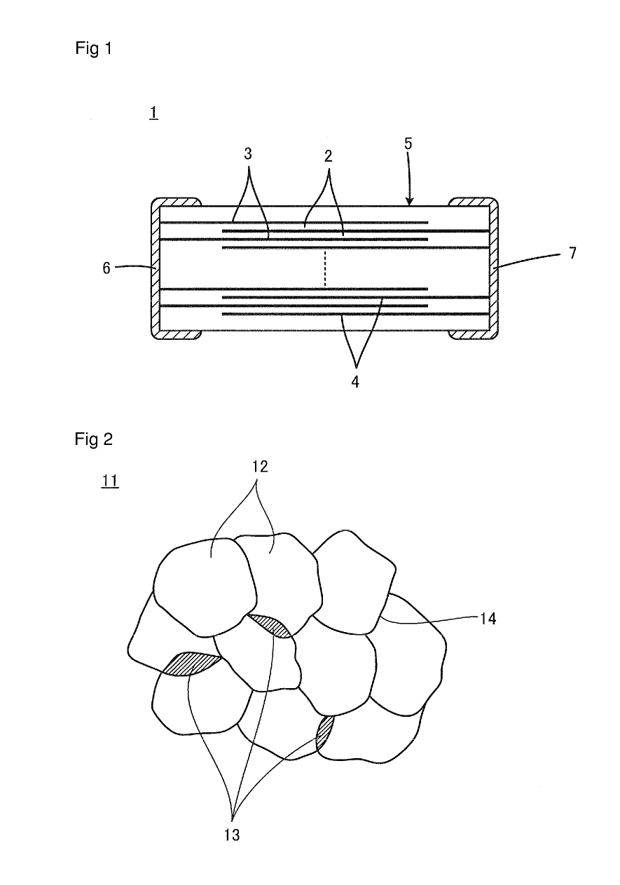

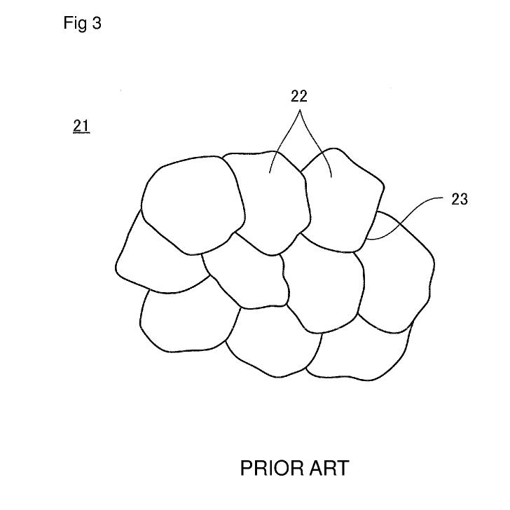

With reference to FIG. 1, a laminated ceramic capacitor 1 will be first described to which a dielectric ceramic according to the present invention is applied.

The laminated ceramic capacitor 1 includes a capacitor main body 5 composed with the use of a plurality of stacked dielectric ceramic layers 2 and a plurality of internal electrodes 3 and 4 formed along the specific interfaces between the dielectric ceramic layers 2. The internal electrodes 3 and 4 may contain, for example, Ni as their main constituent.

First and second external electrodes 6 and 7 are formed in different positions from each other on the outer surface of the capacitor main body 5. The external electrodes 6 and 7 may contain, for example, Ag or Cu as their main constituent. In the case of the laminated ceramic capacitor 1 shown in FIG. 1, the first and second external electrodes 6 and 7 are formed on respective end surfaces of the capacitor main body 5 opposed to each other. The internal electrodes 3 and 4 include a plurality of first internal electrodes 3 electrically connected to the first external electrode 6 and a plurality of second internal electrodes 4 electrically connected to the second external electrode 7, and the first and second internal electrodes 3 and 4 are alternately arranged in the stacking direction.

In this laminated ceramic capacitor 1, the dielectric ceramic layers 2 are composed of a dielectric ceramic containing ABO₃ (A necessarily contains Ba, and optionally further contains at least one of Ca and Sr, whereas B necessarily contains Ti, and optionally further contains at least one of Zr and Hf) as its main constituent and containing a rare earth element Re (Re is at least one of Dy, Ho, Sc, Y, Gd, Er, Yb, Tb, Tm, and Lu) as an accessory constituent. This dielectric ceramic enlarged is schematically shown in FIG. 2.

Referring to FIG. 2, the dielectric ceramic 11 includes main phase grains 12 which are composed of the main constituent mentioned above and secondary phase grains 13 which have a different composition from the main phase grains 12, and grain boundaries (including triple points) 14 are formed between these grains 12 and 13. The present invention is characterized in that more Re is distributed so as to be concentrated in the secondary phase grains 13, in such a way that the ratio of the content of Re in the secondary phase grains 13 to the total content of Re in the dielectric ceramic 11 is 50% or more.

The secondary phase grains 13 have a different composition from the main phase grains 12 as described above, and the difference in composition is clear, which is observed as a segregated object in a SEM-WDX mapping analysis.

In the dielectric ceramic 11 according to the present invention, more Re is concentrated in the secondary phase grains 13. Therefore, the dielectric ceramic 11 has a reduced amount of Re present at the grain boundaries 14.

As described above, more Re is locally concentrated in the secondary phase grains 13, rather than broadly distributed in the dielectric ceramic 11. Thus, a state is achieved in which there is only a small number of low dielectric constant phases which are relatively large in size. Therefore, the low dielectric constant phases at grain boundaries 14 can be substantially ignored.

In this case, when a straight line extending in the stacking direction is drawn between the internal electrodes and 4 shown in FIG. 1, there are a small number of secondary phase grains 13 distributed among the main phase grains 12 along this straight line, such as, for example, main phase grain—main phase grain—main phase grain—secondary phase grain—main phase grain—main phase grain—main phase grain— . . . . When the combined capacitance of the dielectric ceramic layers 2 between the internal electrodes 3 and 4, the capacitance of the main phase grain 12, and the capacitance of a low dielectric constant phase in the second phase grain 13 are denoted respectively by C, C1, and C2, the combined capacitance C is represented as follows.

1/C=1/C1+1/C1+1/C1+1/C2+1/C1+1/C1+1/C1+

The small number of terms 1/C2 suppresses an increase in value of 1/C. As a result, the reduction in combined capacitance C is minimized.

From this consideration, it is determined that Re is preferably locally distributed in the secondary phase grains 13, rather than broadly distributed at the grain boundaries 14, in that a reduction in the dielectric constant can be suppressed as long as the same total amount of Re remains the same.

In addition, the content of Re in the second phase grains 13 is preferably 30 mol % or more. This Re content allows the secondary phase grains 13 to be reduced in size without increasing the number of secondary phase grains 13. As a result, the insulation resistance of the laminated ceramic capacitor 1 can be improved, and the reliability thereof can be improved.

An experimental example will be described below which was carried out in accordance with the present invention.

### (A) Preparation of Ceramic Raw Material

First, a BaTiO₃ powder was prepared as a main constituent powder.

SiO₂ was selected as a sintering aid containing Si, and this SiO₂ powder and respective powders of BaCO₃, MgCO₃, Re₂O₃, and MnCO₃ as additive constituents were prepared. Respective powders of Dy₂O₃, Ho₂O₃, Sc₂O₃, Y₂O₃, Gd₂O₃, Er₂O₃, Yb₂O₃, Tb₂O₃, and Lu₂O₃ were prepared as the Re₂O₃ powder.

Then, the respective powders of SiO₂, BaCO₃, MgCO₃, Re₂O₃, and MnCO₃ were added to the BaTiO₃ powder as a main constituent powder, so as to obtain 1.5 mol of Re, 1.0 mol of Mg, 2.0 mol of Si, and 0.5 mol of Mn with respect to 100 mol of BaTiO₃, and Ba/Ti=1.010. The type of Re for the added Re₂O₃ powder was selected as shown in Table 1.

The prepared powder described above was subjected to wet mixing in a ball mill for 24 hours, and then dried, thereby providing a ceramic raw material.

### (B) Preparation of Laminated Ceramic Capacitor

The ceramic raw material obtained was combined with a polyvinyl butyral based binder and an organic solvent such as ethanol, and subjected to wet mixing in a ball mill for 30 hours to prepare a ceramic slurry.

Next, the ceramic slurry is formed into the shape of a sheet by the doctor blade method so that when fired, the dielectric ceramic layers had a thickness of 1.0 μm, thereby providing rectangular ceramic green sheets.

A conductive paste containing Ni as a main constituent was applied by screen printing onto the ceramic green sheets, thereby forming conductive paste films to serve as internal electrodes.

Then, the ceramic green sheets with the conductive paste films formed were stacked in such a way that the sides with the conductive paste films drawn thereto were alternated, thereby providing a raw laminate to serve as a capacitor main body.

The raw laminate was heated to a temperature of 300° C. in a N₂ atmosphere to burn off the binder, and a firing step was then carried out under the conditions of maintaining a top temperature of 1200° C. for 10 minutes in a reducing atmosphere composed of a H₂—N₂—H₂O gas with an oxygen partial pressure set to 5.33×10⁻¹⁰ MPa.

In the firing step, the rate of temperature decrease in the case of temperature decrease from the top temperature, as well as the top temperature, time, and oxygen partial pressure in the case of keeping the temperature decrease were respectively varied as shown in the respective columns of “Rate of Temperature Decrease”, as well as “Temperature”, “Time”, and “Oxygen Partial Pressure” of “Conditions for Keeping Temperature Decrease” in Table 1, thereby preparing some samples with varying secondary phase areas and Re contents (Re distribution states).

A Cu paste containing a B₂O₃—Li₂O—SiO₂—BaO based glass frit was applied to the both end surfaces of the capacitor main body obtained in the way described above, and fired at a temperature of 800° C. in a N₂ atmosphere to form external electrodes electrically connected to the internal electrodes, thereby providing a series of laminated ceramic capacitors as samples.

The laminated ceramic capacitors thus obtained had outer dimensions of 1.6 mm in width, 3.2 mm in length, and 1.0 mm in thickness, and the dielectric ceramic layers interposed between the internal electrodes had a thickness of 1.0 μm. In addition, the number of the effective dielectric ceramic layers was 50, and the area of the electrode opposed per ceramic layer was 3.2 mm².

### (C) Evaluation of Electrical Properties

Next, the laminated ceramic capacitors obtained were evaluated for the dielectric constant at room temperature, dielectric loss, capacitance temperature characteristics, high temperature load life characteristics, and the insulation resistance at high temperature, as shown in Table 2.

More specifically, the capacitance and dielectric loss (tan δ) were measured under the conditions of a temperature of 25° C., 120 Hz, and 0.5 Vrms. The dielectric constant was obtained from the obtained capacitance.

In addition, the rate of capacitance change at −25° C. to 85° C. was obtained with a capacitance at 25° C. as a standard for indicating the capacitance temperature characteristics, and Table 2 shows maximum values for the rate of capacitance change.

For determining the high temperature load life characteristics, 100 samples were subjected to a high temperature load life test in which voltages of 10 V and 20 V (respectively for electric field intensities of 10 kV/mm and 20 kV/mm) are applied at a temperature of 105° C., and a sample was determined to be a defective if the insulation resistance value was decreased to 200 kΩ or less before a lapse of each of 1000 hours and 2000 hours, thereby obtaining the number of detectives.

Furthermore, a voltage of 10 V (for an electric field intensity of 10 kV/mm) was applied at a temperature of 125° C., and the log IR was calculated from the current value after a lapse of 60 seconds, to obtain the insulation resistance (IR) at high temperature.

### (D) Evaluation of Secondary Phase

In this experimental example, the secondary phase grain was defined as having a phase which is clearly different in composition from the main phase grains composed of BaTiO₃, with a circle-equivalent diameter of 0.1 μm or more in cross section.

One 50 μm×50 μm field of view from SEM was subjected to WDX mapping to identify the secondary phase grains containing Re. This observation was carried out for a total of 5 fields of view. The average composition values for multiple secondary phase grains identified by this observation are shown in the column “Secondary Phase Composition” of Table 1. It is to be noted that while the secondary phase is an oxide, the compositions excluding oxygen are represented in the column “Secondary Phase Composition” of Table 1. In addition, the total of the areas of the identified secondary phase grains was obtained to obtain the area ratio (%) of the total area to the area for all of the fields of view. This area ratio is shown in the column “Area Ratio of Secondary Phase” of Table 1.

In addition, the Re content ratio (mol %) in the column “Secondary Phase Composition” is multiplied by the “Area Ratio of Secondary Phase” to obtain the content ratio of Re in the secondary phase and divided by the total Re content (1.5 mol %) to obtain the ratio of Re concentrated in the secondary phase grains with respect to to the total Re content. The obtained ratio is shown in the column “Re content in Secondary Phase/Total Re Content” of Table 1.

TABLE 1

| | | | | | | | | | | | | | | Re content |
|---|---|---|---|---|---|---|---|---|---|---|---|---|---|---|
| | | Conditions for Keeping | | | | | | | | | | | | in |
| | | Temperature Decrease | | | | | | | | | | | Area | Secondary |
| | | | | Oxygen | Rate of | Average | | | | | | | Ratio of | Phase/ |
| | | | | Partial | Temperature | Grain | Re | Secondary Phase | | | | | Secondary | Total Re |
| Sample | Type | Temperature | Time | Pressure | Decrease | Diameter | Amount | Composition (mol %) | | | | | Phase | Content |
| No. | of Re | (° C.) | (min) | (10⁻¹⁴ MPa) | (° C./min) | (nm) | (mol %) | Ba | Ti | Ni | Mg | Re | (%) | (%) |
| 1 | Dy | — | 0 | — | 10 | 139.5 | 1.5 | 49 | 13 | 7 | 8 | 23 | 1.9 | 29.1 |
| 2 | Dy | 900 | 10 | 4.43 | 10 | 141.2 | 1.5 | 48 | 12 | 9 | 9 | 22 | 2.9 | 42.5 |
| 3 | Dy | 900 | 30 | 4.43 | 10 | 143.2 | 1.5 | 48 | 12 | 7 | 8 | 25 | 3.1 | 51.7 |
| 4 | Dy | 900 | 60 | 4.43 | 10 | 143.7 | 1.5 | 48 | 13 | 8 | 8 | 23 | 4.0 | 61.3 |
| 5 | Dy | 900 | 60 | 4.43 | 20 | 146.9 | 1.5 | 44 | 12 | 4 | 6 | 34 | 3.1 | 70.3 |
| 6 | Dy | 900 | 60 | 4.43 | 30 | 146.1 | 1.5 | 40 | 10 | 4 | 7 | 39 | 2.9 | 75.4 |
| 7 | Dy | 900 | 60 | 4.43 | 60 | 143.2 | 1.5 | 31 | 9 | 5 | 12 | 43 | 2.8 | 80.3 |
| 8 | Dy | 1000 | 60 | 2.37 | 10 | 147 | 1.5 | 47 | 13 | 6 | 11 | 23 | 4.5 | 69.0 |
| 9 | Dy | 950 | 60 | 3.38 | 10 | 142.1 | 1.5 | 44 | 13 | 6 | 9 | 28 | 4.2 | 78.4 |
| 10 | Dy | 850 | 60 | 0.617 | 10 | 147.9 | 1.5 | 41 | 11 | 3 | 12 | 33 | 2.9 | 63.8 |
| 11 | Dy | 800 | 60 | 0.061 | 10 | 145.3 | 1.5 | 38 | 9 | 3 | 14 | 36 | 2.8 | 67.2 |
| 12 | Ho | 900 | 60 | 4.43 | 10 | 143.1 | 1.5 | 47 | 13 | 9 | 8 | 23 | 3.9 | 59.8 |
| 13 | Sc | 900 | 60 | 4.43 | 10 | 145.2 | 1.5 | 49 | 11 | 8 | 8 | 24 | 3.8 | 60.8 |
| 14 | Y | 900 | 60 | 4.43 | 10 | 144.1 | 1.5 | 48 | 12 | 9 | 9 | 22 | 4.2 | 61.6 |
| 15 | Gd | 900 | 60 | 4.43 | 10 | 142.1 | 1.5 | 49 | 13 | 7 | 7 | 24 | 3.7 | 59.2 |
| 16 | Er | 900 | 60 | 4.43 | 10 | 139.8 | 1.5 | 48 | 11 | 9 | 8 | 24 | 3.9 | 62.4 |
| 17 | Yb | 900 | 60 | 4.43 | 10 | 140.2 | 1.5 | 48 | 14 | 8 | 9 | 21 | 4.5 | 63.0 |
| 18 | Tb | 900 | 60 | 4.43 | 10 | 140.6 | 1.5 | 47 | 15 | 7 | 8 | 23 | 4.2 | 64.4 |
| 19 | Tm | 900 | 60 | 4.43 | 10 | 142.1 | 1.5 | 48 | 12 | 8 | 9 | 23 | 4.2 | 64.4 |
| 20 | Lu | 900 | 60 | 4.43 | 10 | 145.1 | 1.5 | 47 | 12 | 8 | 9 | 24 | 3.8 | 60.8 |
| 21 | Dy, Y | 900 | 60 | 4.43 | 10 | 142.9 | 1.0, 0.5 | 48 | 13 | 9 | 8 | 22 | 4.2 | 61.6 |

TABLE 2

| | | | Rate of | | High Temperature Load Life Test | | | |
|---|---|---|---|---|---|---|---|---|
| | | | Capacitance | | 1000 hours | | 2000 hours | |
| Sample | Dielectric | tan δ | Change | | 10 | 20 | 10 | 20 |
| No. | Constant ε | [%] | [%] | logIR | [kv/mm] | [kv/mm] | [kv/mm] | [kv/mm] |
| 1 | 2620 | 2.1 | −13.1 | 9.5 | 0/100 | 0/100 | 0/100 | 2/100 |
| 2 | 2710 | 2.1 | −13.4 | 9.8 | 0/100 | 0/100 | 1/100 | 3/100 |
| 3 | 2850 | 2.3 | −13.6 | 9.5 | 0/100 | 0/100 | 0/100 | 3/100 |
| 4 | 3040 | 2.8 | −14.4 | 9.9 | 0/100 | 0/100 | 1/100 | 5/100 |
| 5 | 3120 | 2.9 | −14.1 | 9.5 | 0/100 | 0/100 | 0/100 | 0/100 |
| 6 | 3170 | 3.0 | −14.1 | 9.5 | 0/100 | 0/100 | 0/100 | 0/100 |
| 7 | 3250 | 3.2 | −15.0 | 9.7 | 0/100 | 0/100 | 0/100 | 0/100 |
| 8 | 3200 | 3.1 | −14.8 | 9.3 | 0/100 | 0/100 | 2/100 | 7/100 |
| 9 | 3180 | 3.1 | −14.3 | 9.2 | 0/100 | 0/100 | 1/100 | 3/100 |
| 10 | 3150 | 3.2 | −14.5 | 9.8 | 0/100 | 0/100 | 0/100 | 0/100 |
| 11 | 3090 | 3.2 | −14.8 | 9.6 | 0/100 | 0/100 | 0/100 | 0/100 |
| 12 | 2980 | 2.1 | −13.8 | 9.5 | 0/100 | 0/100 | 0/100 | 3/100 |
| 13 | 3120 | 2.9 | −12.9 | 9.5 | 0/100 | 0/100 | 0/100 | 5/100 |
| 14 | 2960 | 2.1 | −13.4 | 9.4 | 0/100 | 0/100 | 1/100 | 7/100 |
| 15 | 3130 | 2.8 | −14.2 | 9.3 | 0/100 | 0/100 | 0/100 | 3/100 |
| 16 | 3050 | 2.6 | −12.9 | 9.5 | 0/100 | 0/100 | 1/100 | 5/100 |
| 17 | 3100 | 3.0 | −14.3 | 9.6 | 0/100 | 0/100 | 0/100 | 2/100 |
| 18 | 3010 | 2.7 | −13.7 | 9.7 | 0/100 | 0/100 | 0/100 | 2/100 |
| 19 | 2960 | 2.7 | −13.8 | 9.6 | 0/100 | 0/100 | 1/100 | 6/100 |
| 20 | 2970 | 3.0 | −12.9 | 9.2 | 0/100 | 0/100 | 1/100 | 5/100 |
| 21 | 3020 | 3.1 | −14.2 | 9.5 | 0/100 | 0/100 | 0/100 | 3/100 |

Samples 1 to 11 which employs Dy as Re are first compared with each other.

As can be seen from Tables 1 and 2, samples 1 and 2 have relatively low dielectric constants, and the “Re content in Secondary Phase/Total Re Content” is less than 50% for samples 1 and 2.

In contrast to these samples, samples 3 and 4 have higher dielectric constants than those of samples 1 and 2, and the “Re content in Secondary Phase/Total Re Content” is 50% of more for samples 3 and 4, in spite of the from “Average Grain Diameter” values being comparable to those of samples 1 and 2.

Samples 5 to 11 also have higher dielectric constants than those of samples 1 and 2, and the “Re content in Secondary Phase/Total Re Content” is 50% of more in samples 5 to 11.

Among these samples 5 to 11, the Re content ratio in the column “Secondary Phase Composition” is 30 mol % or more for samples 5, 6, 7, 10, and 11. As can be seen from the “the number of defectives in 2000 hours”, these samples 5, 6, 7, 10, and 11 have further improved reliability.

It is determined that even when the type of the rare earth element Re is changed as in the case of samples 12 to 21, samples 12 to 21 produce substantially the same effect as in the case of, for example, sample 4 using Dy as Re.

While a case of Ba for A and Ti for B has been described with respect to the main constituent ABO₃ of the dielectric ceramic in the experimental example described above, it has been confirmed that substantially the same results are obtained even when some of Ba is substituted with at least one of Ca and Sr, or even when some of Ti for B is substituted with at least one of Zr and Hf.

What is claimed is:

1. A dielectric ceramic comprises ABO₃ as its main constituent and Re as an accessory constituent,
wherein A is Ba or Ba combined with at least one of Ca and Sr, B is Ti or Ti combined with at least one of Zr and Hf, and Re is at least one of Dy, Ho, Sc, Y, Gd, Er, Yb, Tb, Tm, and Lu, and
wherein the dielectric ceramic includes main phase grains including the main constituent and secondary phase grains having a different composition from the main phase grains, and wherein the ratio of the Re content in the secondary phase grains to the total content of Re in the dielectric ceramic is 50% or more.

2. The dielectric ceramic according to claim 1, wherein the content of Re in the secondary phase grains is 30 mol % or more.

3. The dielectric ceramic according to claim 2, wherein A is Ba and B is Ti.

4. The dielectric ceramic according to claim 3, wherein Re is a single member of said group.

5. The dielectric ceramic according to claim 4, wherein Re is Dy.

6. The dielectric ceramic according to claim 1, wherein A is Ba and B is Ti.

7. The dielectric ceramic according to claim 6, wherein Re is a single member of said group.

8. The dielectric ceramic according to claim 7, wherein Re is Dy.

9. The dielectric ceramic according to claim 7, wherein the ratio of the Re content in the secondary phase grains to the total content of Re in the dielectric ceramic is 59.2% or more.

10. The dielectric ceramic according to claim 1, wherein the content of Re in the secondary phase grains is 33 mol % or more.

11. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 10.

12. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 9.

13. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 8.

14. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 7.

15. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 6.

16. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 5.

17. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 4.

18. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 3.

19. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 2.

20. A laminated ceramic capacitor comprising a capacitor main body which comprises a plurality of stacked dielectric ceramic layers and a plurality of internal electrodes each of which is disposed at a different interface between the dielectric ceramic layers; and a pair of external electrodes at different positions from each other on an outer surface of the capacitor main body and electrically connected to different ones of the internal electrodes, wherein the dielectric ceramic layers are composed of the dielectric ceramic according to claim 1.
